(19) United States
(12) Patent Application Publication
(10) Pub. No.: US 2008/0264273 A1
(43) Pub. Date: Oct. 30, 2008

(54) SNIPPER KNIFE STEM

(76) Inventor: Glenn W. Stousland, Beaver Dam, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 12/138,220

(22) Filed: Jun. 12, 2008

Related U.S. Application Data
(63) Continuation-in-part of application No. 11/264,565, filed on Nov. 1, 2005.

(51) Int. Cl. A23N 15/12; B26D 1/00

(52) U.S. Cl. 99/636; 83/859

(57) ABSTRACT

A snipping apparatus includes a frame having an inlet end and an outlet end, a rotatable drum mounted in the frame, and a plurality of mounting rods fixed relative to the frame. The mounting rods extend between the inlet end and the outlet end and are aligned generally parallel to a longitudinal axis of the drum. The snipping apparatus also includes a plurality of resilient rods, each resilient rod having a first end, a second end and a curved portion positioned between the first end and the second end, and a plurality of snipper knives, such that each of the knives is coupled to a free end of one of the resilient rods.

### CROSS-REFERENCE TO RELATED APPLICATIONS

This application is a continuation-in-part of U.S. patent application Ser. No. 11/264,565, entitled “SNIPPER KNIFE”, filed Nov. 1, 2005 by David R. Zittel and Glenn W. Stousland, the entire contents of which are incorporated herein by reference.

### BACKGROUND

The present invention relates to a snipping apparatus for processing elongated vegetable products, such as beans and the like, and in particular, a snipper knife stem for supporting a snipper knife.

Snipping apparatus systems are used to remove the ends from beans prior to canning or other packaging of the beans. A widely used system includes a frame and a rotating drum structure with a mass of beans moving from one end of the drum to another end. The periphery of the drum is slotted, and the slots are sized and shaped to permit projection of one end of a bean through the slot while preventing the entire bean from falling through the slot. A plurality of snipper knives are mounted to engage the peripheral surface of the drum. As the drum rotates, the snipper knives cut the ends of the beans that protrude through the slots.

The snipper knives are mounted against the drum using a knife holder assembly. A plurality of mounting rods are attached to the apparatus frame, which extend along a length of the drum parallel to the peripheral surface. Each knife is attached to a knife stem, which is attached to one of the mounting rods. In such knife holder assemblies, as the drum rotates, the snipper knives and/or the knife stems can be damaged or broken due to irregularities in the drum, high rotational speed of the drum, or a piece of foreign material or debris caught in the drum, such as a stick or a bean stalk. The normal oscillations of the snipper knife, and thus the snipper knife stem, eventually, and often prematurely cause the snipper knife stem to fail because of low durability and flexibility of the snipper knife.

### SUMMARY

In one embodiment, the invention provides a snipping apparatus including a frame having an inlet end and an outlet end, a rotatable drum mounted in the frame, and a plurality of mounting rods fixed relative to the frame. The mounting rods extend between the inlet end and the outlet end and are aligned generally parallel to a longitudinal axis of the drum. A plurality of resilient rods, each having a first end, a second end and a curved portion positioned between the first end and the second end, and a plurality of snipper knives, such that each of the knives is coupled to a free end of one of the resilient rods.

In another embodiment, the invention provides a knife assembly for a snipping apparatus including a resilient rod having a first end configured for coupling to the snipping apparatus, a second end, and a curved portion positioned between the first end and the second end. The knife assembly further includes a snipper knife coupled to the second end of the resilient rod and having at least one cutting edge configured for engaging the drum.

In yet another embodiment the invention provides a knife stem for coupling a snipper knife to a snipping apparatus. The knife stem includes an elongate resilient rod having a first end configured for coupling to the snipping apparatus, a second end configured for coupling to the snipper knife, and a curved portion positioned between the first end and the second end for permitting relative movement of the snipper knife with respect to the snipping apparatus.

Other aspects of the invention will become apparent by consideration of the detailed description and accompanying drawings.

### BRIEF DESCRIPTION OF THE DRAWINGS

FIG. 1 is a side view of a bean snipping apparatus illustrating a snipper knife and stem for use with the apparatus.

FIG. 2 is a perspective view of the snipper knife and stem according to one embodiment of the invention.

FIG. 3 is a side view of the stem shown in FIG. 2.

FIG. 4 is a top view of the stem shown in FIG. 2.

FIG. 5 is a perspective view of a snipper knife and stem according to another embodiment of the invention.

FIG. 6 is a side view of the stem of FIG. 5.

FIG. 7 is a top view of the stem of FIG. 5.

FIG. 8 is a top view of a stem according to another embodiment of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

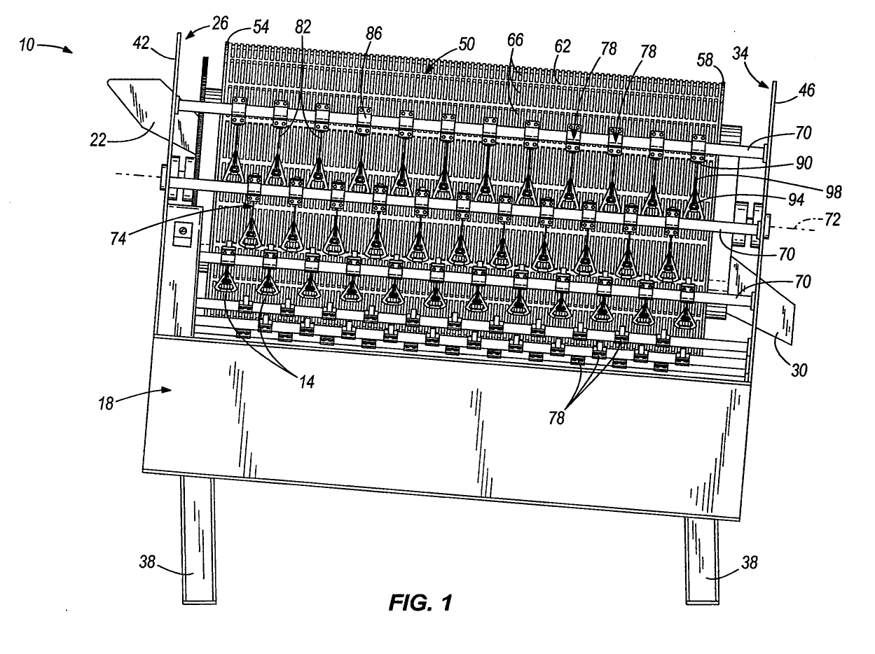

FIG. 1 illustrates a snipping apparatus 10 for processing elongated vegetable products, such as beans and the like, and removing an end portion of each bean. In particular, the snipping apparatus 10 includes a plurality of snipper knives 14 for cutting the end portions of the beans. In some embodiments, the snipper knives 14 are a non-metallic material, such as plastic, whereas in other embodiments, the snipper knives 14 are metallic.

The snipping apparatus 10 includes a frame 18 having an infeed chute 22 at an inlet end 26 and a discharge chute 30 at an outlet end 34. The frame 18 is supported by legs 38 that rest upon a support surface and space the frame 18 above the support surface. The inlet end 26 of the frame 18 includes an inlet end wall 42 that defines an opening (not shown) for receiving the infeed chute 22. Similar to the inlet end 26, the outlet end 34 of the frame 18 includes an outlet end wall 46 that defines an opening (not shown) for receiving the discharge chute 30. The frame 18 is preferably made of stainless steel or another suitable material for food processing applications.

A rotatable drum 50 is mounted in the frame 18 and is configured to transport beans received in the snipping apparatus 10 from the inlet end 26 to the outlet end 34 of the frame 18. Generally, the drum 50 is positioned at an incline relative to the support surface to permit the beans to travel from the inlet end 26 to the outlet end 34 of the apparatus 10. In the illustrated embodiment, the inlet end 26 of the frame 18 is spaced further from the support surface than the outlet end 34 of the frame 18 to create the inclined drum 50, i.e., the frame leg at the inlet end 26 of the frame 18 is taller than the frame leg at the outlet end 34.

The drum 50 includes an inlet end wall 54 proximate the inlet end wall 42 of the frame 18 and an outlet end wall 58 proximate the outlet end wall 46 of the frame 18. The infeed chute 22 communicates with an opening (not shown) in the inlet end wall 54 to deposit food product in the drum 50 and the discharge chute 30 communicates with an opening (not shown) in the outlet end wall 58 to receive food product from the drum 50. The drum 50 includes a generally cylindrical and perforate sidewall 62 that extends between the inlet end wall 54 and the outlet end wall 58. The sidewall 62 includes a plurality of elongated slots 66 that extend completely therethrough. The slots 66 are sized and configured to permit ends of the beans to pass through the slots 66 to the exterior of the drum 50, while preventing the entire bean from falling out of the drum 50 through the slots 66.

Although not shown in FIG. 1, it should be readily apparent to those of skill in the art that the drum 50 includes means for facilitating the transfer the beans from the inlet end 26 to the outlet end 34, such as baffles, partitions, or the like. Further, the snipping apparatus 10 may include a cover that mates with the frame 18 to substantially enclose the drum 50.

A plurality of mounting rods 70 are coupled to the frame 18 and extend between the inlet end wall 42 and the outlet end wall 46 of the frame 18. The mounting rods 70 are aligned generally parallel to a longitudinal axis 72 of the drum 50. The mounting rods 70 are arranged around the circumference of the drum 50 except an uppermost portion of the drum 50, although in a further embodiment, the mounting rods 70 may be arranged about the entire circumference of the drum 50 or other portions of the drum 50 and may be non-parallel to the longitudinal axis 72 of the drum 50. In the illustrated embodiment, the mounting rods 70 are fixed relative to the frame 18, however, in another embodiment, the mounting rods 70 may be oscillated to thereby oscillate the snipper knives 14 back and forth relative to the drum 50.

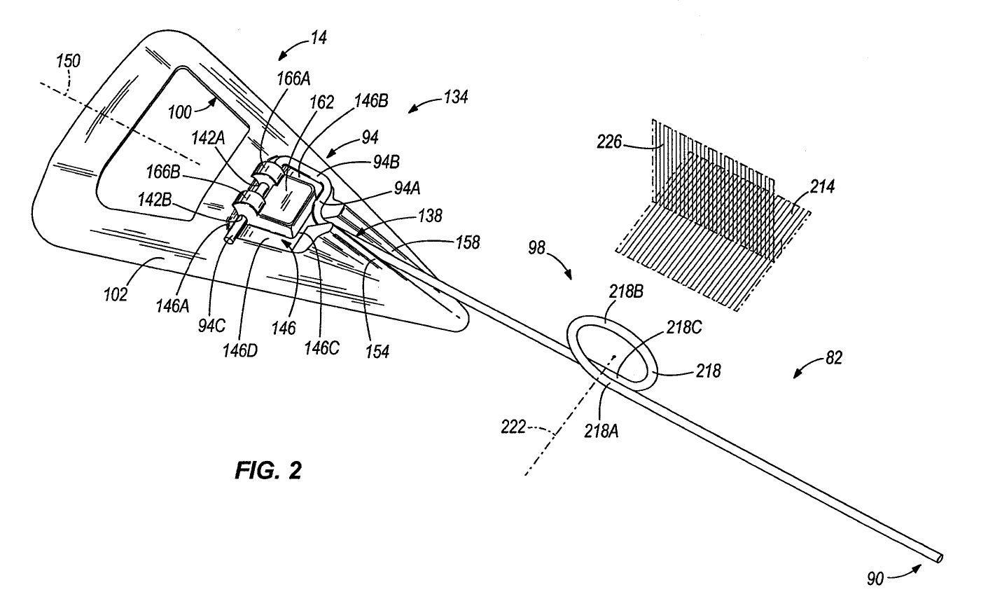

Knife holder assemblies 74 are coupled to each mounting rod 70 and extend along the length of the drum 50. The snipper knives 14 are mounted against the drum 50 by the respective knife holder assembly. In the illustrated embodiment, the knife holder assemblies 74 are spaced apart equidistantly. Each knife holder assembly 74 includes a clamp 78 (or assembly holder), a knife stem 82, such as a resilient rod, and a snipper knife 14. The clamp 78 is mounted to the mounting rod and includes a pair of plate members 86 that capture the mounting rod 70. The resilient rod 82 includes a first end 90 coupled to the clamp 78, a second end 94 coupled to the snipper knife 14 (FIG. 2), and a main portion 98 positioned between the first end 90 and the second end 94. In the illustrated embodiment, the resilient rod 82 is formed by a semi-flexible metal rod that biases the snipper knife 14 against the drum 50 such that the snipper knife 14 engages the drum 50. The resilient rod 82 puts pressure on the knife 14 radially to the longitudinal axis 72 of the drum 50.

FIGS. 2-4 illustrate one embodiment of the resilient rod 82 and an example of the snipper knife 14 in greater detail. The first end 90 of the resilient rod 82 has a substantially linear shape for coupling to the clamp 78, and the second end 94 of the resilient rod 84 is substantially J-shaped for coupling to the snipper knife 14. The second end 94 of the resilient rod 82 includes a first section 94A, a second section 94B and a third section 94C defining the J-shape.

As shown in FIG. 2, the snipper knife 14 includes a knife body 100 having a generally triangular shape and a top surface 102. An attachment system 134 is formed in the top surface 102 of the knife body 100 for attaching the resilient rod 82 to the snipper knife 14. The attachment system 134 includes a channel 138, a pair of bores 142A, 142B and recess portion 146 (including 146A, 146B, 146C, 146D). The channel 138 is formed along a longitudinal axis 150 of the knife body 100 and is defined by two sidewalls 154, 158 to provide a friction fit for retaining a portion of the resilient rod 82 within the channel 138 (FIG. 2). In general, the longer the channel 138, the more secure an attachment between the resilient rod 82 and the snipper knife 14. The top surface 102 of the knife body 100 includes a central area 162 forward of the channel 138 and recessed portions 146A-146D surround all four sides of the central area 162. The top surface 102 includes a pair of arches 166A, 166B that extend over the forward most recessed portion 146A to define the pair of bores 142A, 142B.

The main portion of the resilient rod 82 is received within the channel 138. A first section 94A and a second section 94B of the J-shaped second end 94 are positioned within a rearward most recessed portion 146C and the first side recessed portion 146B, respectively, of the attachment system 134. The third section 94C of the second end 94, which defines a free end of the resilient rod 82, passes through the two bores 142A, 142B. In other embodiments, the two bores 142A, 142B can be replaced by a single bore or other suitable arrangement for retaining the third section 94C on the snipper knife 14. The third section 94C has a length sufficient to prevent the resilient rod 82 from becoming detached from the snipper knife 14 during use.

In a further embodiment, the second end 94 of the resilient rod 82 may be reversed such that the second section 94B is positioned within the opposite side of an opposite side recessed portion 146C and the third section 94C passes through the two bores 142A, 142B in an opposite direction. In the illustrated embodiment, the attachment system 134 is integrally formed in the top surface 102 of the knife body 100, which in combination with the resilient rod 82 and the configuration of the attachment system 134 eliminates the need for additional components to secure the resilient rod 82 to the snipper knife 14. It is to be understood that the particular configuration of the second end 94 of the resilient rod 82 is by way of illustration only, and is not intended to limit the scope of the claimed invention. Other arrangements and configurations of the first end 90 and the second end 94 of the resilient rod 82 are possible and within the scope of one of ordinary skill in the art.

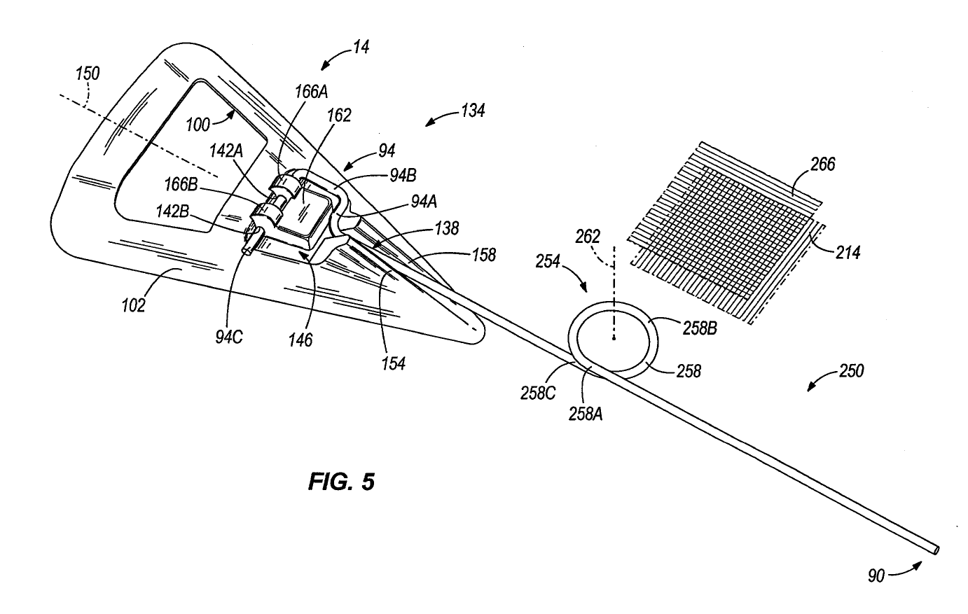

The snipper knife 14 defines a plane 214 along a longitudinal axis or bottom edge of the snipper knife 14. The plane 214 is illustrated in FIGS. 2 and 5 and is positioned off to the side for clarity. The first end 90 and the second end 94 of the rod 82 lie substantially in a resilient rod plane that is generally parallel to the plane 214.

The main portion 98 of the rod 82 includes a curve or loop 218. In the illustrated embodiment, the loop forms a curled or coiled portion that is generally circular. The loop 218 includes a first portion 218A, a second portion 218B and a third portion 218C. The first portion 218A is adjacent the first end 90 of the rod 82 and at least partially lies parallel to the plane 214. The third portion 218C is adjacent the second end 94 of the rod 82 and at least partially lies parallel to the plane 214. The second portion 218B defines the loop 218 relative to the remaining portions of the rod 82 and extends between the first portion 218A and the third portion 218C. The loop 218 extends out of the resilient rod plane, i.e., the plane 214, at an angle of approximately 90° from the resilient rod plane. The loop 218 may extend out of the resilient rod plane at any angle greater than 0°, for example, the loop 218 may extend at an angle between about 30° and about 60°, and more particularly, at an angle of about 45°. It should be readily apparent to those of skill in the art that in further embodiments the loop 218 may have other known shapes, such as elliptical, square, rectangular, triangular, spiral, and other regular or non-regular shapes for connecting the first and second portions. In the non-circular embodiments, two central axes can be included, such as for ovular embodiments.

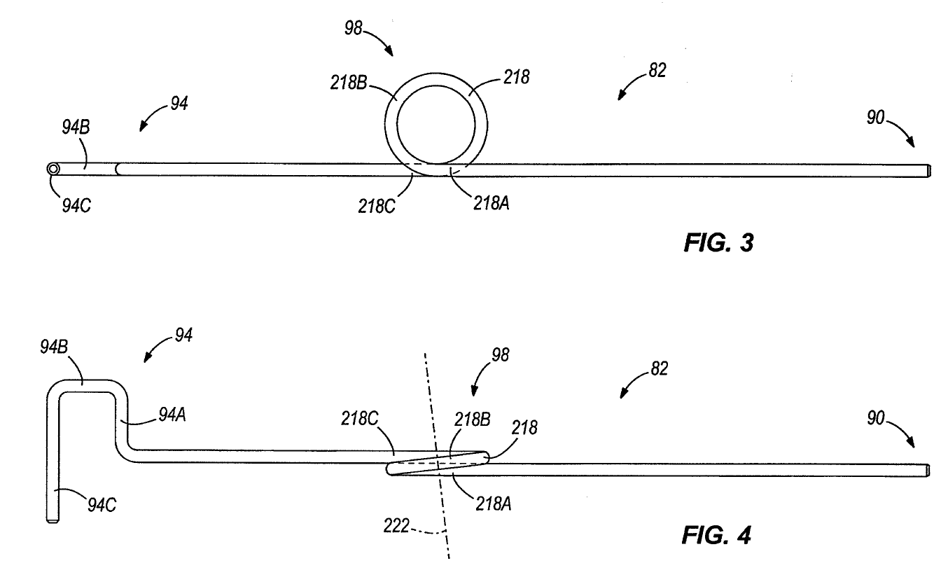

The loop 218 includes a central axis 222 (FIGS. 2 and 4), which extends in a plane generally parallel to the plane 214. The loop 218 extends out of the resilient rod plane (best shown in FIG. 3) and along a plane 226 (FIG. 2) non-parallel to the plane 214. In the illustrated embodiment, the plane 226 is substantially perpendicular to the plane 214 and the resilient rod plane. In one embodiment, the rod 82 is formed from wire and the loop 218 is formed with spring forming equipment. In other embodiments the rod 82 is formed of graphite or fiberglass in any known way, such as by casting, molding, extrusion, etc. The rod 82 may be formed with the loop 218 in place, or the rod 82 may be formed and then the loop 218 is formed in the rod 82.

Prior to operation of the snipping apparatus 10, the knife holder assemblies 74 are mounted to the mounting rods 70 such that the snipper knives 14 are biased against the sidewall 62 of the drum 50. During operation, the drum 50 rotates to transfer beans from the inlet end 26 of the snipping apparatus 10 to the outlet end 34. End portions of the beans project through the slots 66 in the sidewall 62 of the drum 50. As the drum 50 rotates and the end portions pass, the snipper knives 14 cut off the end portions of the beans. The loop 218 enhances durability of the resilient rod 82 by allowing rotation of the rod 82, thereby permitting a portion of the resilient rod 82 to move in response to such stress, rather than transferring stress to the clamp 78. The loop 218 provides flexibility in the resilient rod 82 and thereby to the snipper knife 14 by permitting movement of the rod 82 and the snipper knife 14 toward and away from the drum 50 (i.e. radial movement). For example, the snipper knives 14 may be pushed away from the drum 50 (in the radial direction of the drum 50) or slide along an exterior surface of the drum 50 (in the axial direction of the drum 50) by the beans or by irregularities in the exterior surface of the drum 50. The loop 218 converts bending stresses against the resilient rod 82 to axial stresses along the resilient rod 82. Therefore, the loop 218 inhibits damage or breakage of the snipper knife 14 and the resilient rod 82 during operation. In addition, flexibility provided to the resilient rod 82 by the loop 218 allows a user to remove and replace snipper knives 14 from the rod 82 without loosening the respective knife holder assembly 74 that couples the rod 82 to the mounting rod 70.

FIGS. 5-7 illustrate another embodiment of a resilient rod 250 and the snipper knife 14 in greater detail. The resilient rod 250 is similar to the resilient rod 82 shown in FIGS. 2-4; therefore, like structure will be identified by the same reference numerals. The resilient rod 250 has a first end 90, a second end 94 and a main portion 254. In the illustrated embodiment, the resilient rod 82 is formed by a semi-flexible metal rod that biases the snipper knife 14 against the drum 50 such that the snipper knife 14 engages the drum 50. The second end 94 is coupled to the snipper knife 14 as discussed above with respect to FIG. 2.

The main portion 254 of the resilient rod 250 includes a curve or a loop 258. In the illustrated embodiment, the loop forms a curled or coiled portion that is generally circular. The loop 258 includes a first portion 258A, a second portion 258B and a third portion 258C. The first portion 258A is adjacent the first end 90 of the rod 250 and at least partially lies parallel to the plane 214. The second portion 258B defines the loop 258 relative to the remaining portions of the rod 250 and extends between the first portion 258A and the third portion 258C. The third portion 258C is adjacent the second end 94 and at least partially lies parallel to the plane 214. The second portion 258B extends between the first portion 258A and the third portion 258C to define the loop 258, and is parallel to the plane 214.

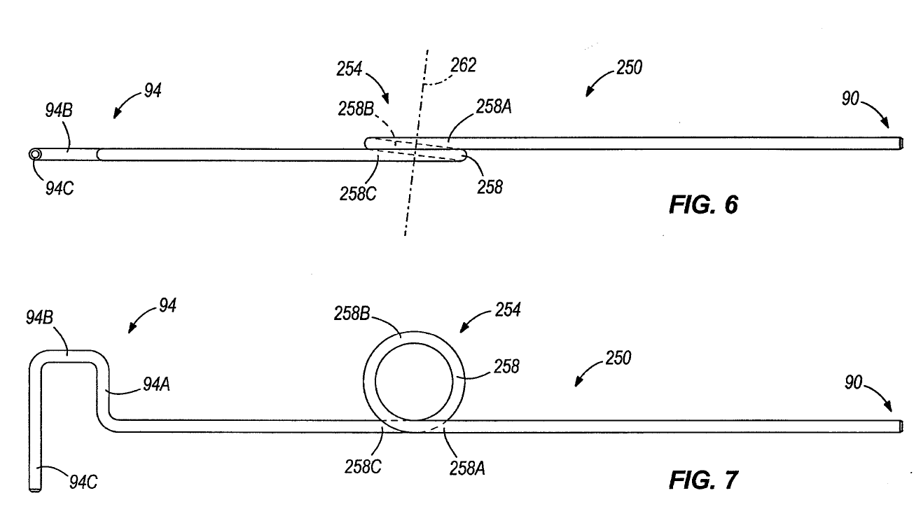

The loop 258 includes a central axis 262 shown in FIGS. 5 and 6. The central axis 262 extends generally perpendicular to the plane 214. The loop 258 extends along the resilient rod plane, as best shown in FIGS. 5-6, and defines a plane 266, shown in FIG. 5. The plane 266 is substantially parallel to the plane 214 and the resilient rod plane. The loop 258 enhances durability of the resilient rod 250 by allowing rotation of the rod 250, and thereby permitting a portion of the resilient rod 250 to move in response to such stress, instead of transferring stress to the clamp 78. Similar to the resilient rod 82 shown in FIGS. 2-4, the loop 258 provides flexibility in the resilient rod 250 to the snipper knife 14 to permit movement along an exterior surface of the drum 50 (in the axial direction of the drum 50) or away from the drum 50 (in the radial direction of the drum 50) by the beans or by irregularities in the exterior surface of the drum 50. Therefore, the loop 258 inhibits damage or breakage of the snipper knife 14 and the resilient rod 250 during operation.

The illustrated rod 250 is formed from wire and the loop 258 is formed with spring forming equipment. In other embodiments the rod 250 may be formed of graphite or fiberglass. The rod 250 and the loop 258 can be formed in any of the manners discussed above. As discussed above with respect to loop 218, the loop 258 may be substantially elliptical, circular, ovular, elliptical, square, rectangular, triangular, spiral or other suitable regular or non-regular shape for connecting the first and second portions. In the non-circular embodiments, two central axes can be included, such as for ovular embodiments.

During operation, each snipper knife 14 slides along the drum 50 in a radial direction. The loop 258 on the resilient rods 250 permits each snipper knife 14 to also slide in an axial direction along the drum 50 as a result of contact with the beans or irregularities in the exterior surface of the drum 50. The loop 258 converts bending stresses against the resilient rod 250 to axial stresses along the resilient rod 250. Therefore, the loop 258 inhibits damage or breakage of the snipper knife 14 and the resilient rod 250 during operation.

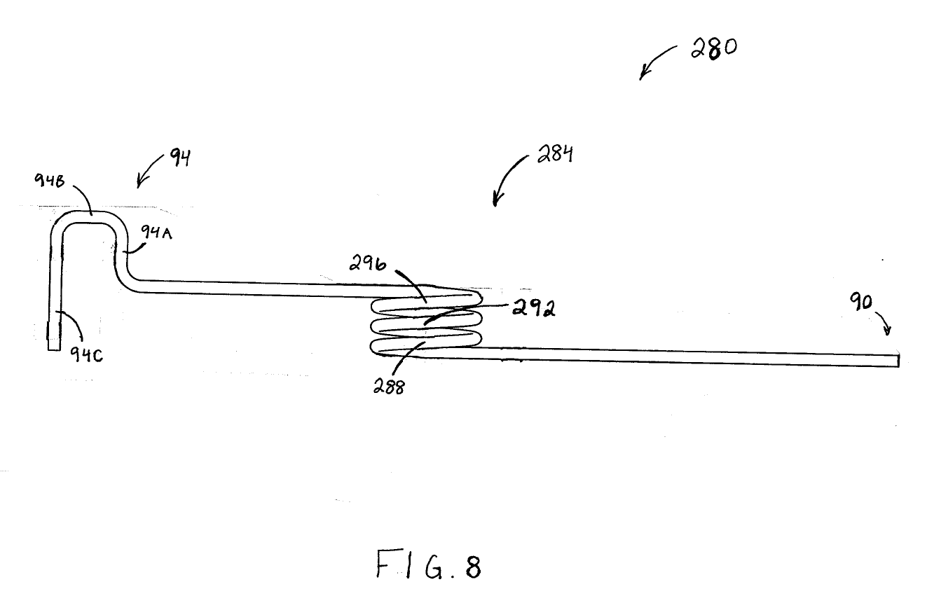

In a further embodiment, the curled portion includes two or more loops, such that the resilient rod travels two or more full circles between the first end and the second end. The two or more loops can be adjacent one another, such that the loops are stacked sideways, to form a coil spring appearance. For example, FIG. 8 illustrates an embodiment of a resilient rod 280 that includes multiple loop configuration. The resilient rod 280 is similar to the resilient rod 82 shown in FIGS. 2-4; therefore, like structure will be identified by the same reference numerals. The resilient rod 280 includes a main portion 284 having a first circular loop 288, a second circular loop 292 and a third circular loop 296 positioned in a side-by-side manner. Each of the first circular loop 288, the second circular loop 292 and the third circular loop 296 travels a single revolution, such that the main portion 284 includes multiple revolutions. Alternatively, the loops may be positioned along the length of the resilient rod in series. In another embodiment, the resilient rod includes an S-shaped portion in place of a loop or each loop 228-296 may be substantially elliptical, circular, ovular, elliptical, square, rectangular, triangular, spiral or other suitable regular or non-regular shape for connecting the first and second portions. These other embodiments also permit the resilient rod to be flexible to permit movement of the snipper knife along or away from the drum to inhibit damage or breakage of the snipper knife and resilient rod.

In yet other embodiments, the loop extends at an angle to or skews to the loop plane 226 and at an angle to or skew to the loop plane 266. In one such embodiment, the angle is between about 30° and about 60°, and in particular, about 45°. In these embodiments, the curled portion can move both axially along the drum 50, and radially toward and away from the drum 50 in response to beans or irregularities in the drum surface.

Various features and advantages of the invention are set forth in the following claims.

What is claimed is:

1. A snipping apparatus comprising:
a frame having an inlet end and an outlet end;
a rotatable drum mounted in the frame;
a plurality of mounting rods fixed relative to the frame, the mounting rods extending between the inlet end and the outlet end and aligned generally parallel to a longitudinal axis of the drum;
a plurality of resilient rods, each resilient rod having a first end, a second end and a curved portion positioned between the first end and the second end; and
a plurality of snipper knives, each of the knives coupled to a free end of one of the resilient rods.

2. The snipping apparatus of claim 1 wherein each of the resilient rods comprises wire.

3. The snipping apparatus of claim 1 wherein the curved portion is formed by spring forming.

4. The snipping apparatus of claim 1, and further comprising a plurality of clamps, wherein each clamp couples one of the resilient rods to the respective mounting rod.

5. The snipping apparatus of claim 1 wherein the curved portion defines a coil.

6. The snipping apparatus of claim 1 wherein the curved portion has a generally circular shape.

7. The snipping apparatus of claim 1, wherein a bottom edge of the knife defines a plane and the curved portion extends substantially parallel to the plane.

8. The snipping apparatus of claim 1 wherein a bottom edge of the knife defines a plane and the curved portion extends substantially perpendicular to the plane.

9. A knife assembly for a snipping apparatus, the knife assembly comprising:
a resilient rod having a first end configured for coupling to the snipping apparatus, a second end, and a curved portion positioned between the first end and the second end; and
a snipper knife coupled to the second end of the resilient rod and having at least one cutting edge configured for engaging the drum.

10. The knife assembly of claim 9 wherein the resilient rod comprises wire.

11. The knife assembly of claim 9 wherein the curved portion of the resilient rod is formed by spring forming.

12. The knife assembly of claim 9, and further comprising a clamp coupled to the first end of the resilient rod for coupling the knife assembly to the snipping apparatus.

13. The knife assembly of claim 9 wherein the curved portion defines a coil.

14. The knife assembly of claim 9 wherein the curved portion of the rod has a generally circular shape.

15. The knife assembly of claim 9 wherein a longitudinal axis of the knife defines a plane and the curved portion extends substantially parallel to the plane.

16. The knife assembly of claim 9 wherein a longitudinal axis of the knife defines a plane and the curved portion extends substantially perpendicular to the plane.

17. The knife assembly of claim 9 wherein a longitudinal axis of the knife defines a plane and the curved portion extends at an angle of between about 30° and about 60° with respect to the plane.

18. The knife assembly of claim 9 wherein the snipper knife comprises plastic.

19. A knife stem for coupling a snipper knife to a snipping apparatus, the knife stem comprising:
an elongate resilient rod having a first end configured for coupling to the snipping apparatus and a second end configured for coupling to the snipper knife; and
a curved portion positioned between the first end and the second end for permitting relative movement of the snipper knife with respect to the snipping apparatus.

20. The stem of claim 19 wherein the resilient rod defines a plane and the curved portion extends substantially parallel to the plane.

21. The stem of claim 19 wherein the resilient rod defines a plane and the curved portion extends substantially perpendicular to the plane.

22. The stem of claim 19 wherein the resilient rod defines a plane and the curved portion extends at an angle relative to the plane.

23. The stem of claim 19 wherein the curved portion includes multiple revolutions.
